(19) United States
(12) Patent Application Publication
(10) Pub. No.: US 2012/0017035 A1
(43) Pub. Date: Jan. 19, 2012

(54) RUNTIME REPROGRAMMING OF A PROCESSOR CODE SPACE MEMORY AREA

(75) Inventors: Shigekatsu TATENO, Abingdon (GB); Julien MARGETTS, Thame (GB)

(73) Assignee: PLX TECHNOLOGY, INC., Sunnyvale, CA (US)

(21) Appl. No.: 12/837,730

(22) Filed: Jul. 16, 2010

(51) Int. Cl. G06F 12/02

(52) U.S. Cl. 711/103; 711/E12.008

(57) ABSTRACT

In a first embodiment of the present invention, a method for allowing a microprocessor to access a flash memory is provided, the method comprising: fetching code instructions and data from the flash memory via a unidirectional code bus coupled to a flash controller, which is coupled to a databus interface, which is coupled to the flash memory; executing the code instructions in a manner that is substantially similar to that as used for a read only memory (ROM) coupled to the microprocessor; and writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

### BACKGROUND OF THE INVENTION

1. Field of the Invention

The present invention relates generally to computer processors. More specifically, the present invention relates to the runtime reprogramming of a processor code space memory area.

2. Description of the Related Art

The Intel™ 8051 Microprocessor is a versatile single chip microprocessor used in embedded applications. There are a number of different 8051-compatible devices that utilize the 8051 microprocessor and extend its functionality.

The 8051 architecture is based on the Harvard architecture, which employs separate code and data buses. The 8051 includes an instruction bus providing a code address space that can be read by the 8051 central processing unit (CPU). This code space, however, is read-only. Typically this code space will contain software instructions, such as bootcode (code executed upon starting up the machine), and sometimes some additional application code as well. However, the fact that the 8051 architecture's instruction bus code space cannot be written to by the CPU makes updating this software difficult. Often the entire memory must be replaced in order to upgrade the bootcode.

A number of manufacturers have extended the capabilities of the 8051 microprocessor by utilizing flash memory. In general, flash memory is non-volatile memory that can be written to via software routines (unlike hard-coded read only memory). Flash memory is packaged with either a parallel or serial interface.

Due to their respective layouts, serial flash memory tends to be more beneficial in many circumstances because parallel flash memory devices require external contact pins, for the parallel address and data buses, causing an increase in the size of the device as compared with serial flash. Serial flash memory is generally lower in cost for this reason. However, it generally does not allow access based on bytes, which means that code cannot be executed directly from it. This is known as eXecute In Place (XIIP), which means code must be copied from the serial flash to a buffer RAM, from where it can be executed, or a specialized flash controller must be used which converts parallel byte level accesses to page based serial level accesses.

Flash memory can be written to by the 8051 microprocessor but only if located on the data bus, and thus application code cannot be updated without needing to swap out physical memory. However, updating application code is still a useful aim as it essentially extends the program capabilities of the 8051 microprocessor beyond what it was initially intended for.

In some instances, manufacturers have moved the entire software to flash memory, allowing for complete upgradability of all the software, which includes the bootcode, the operating system (containing instructions required to manage memory and disk storage, loading and starting applications, and so on) and applications (containing instructions to carry out the specific task required of the device, such as performing the bridging function between a USB bus and a SATA hard disk). Flash memory, however, is slower to access than ROM or RAM in the 8051 code space, so keeping the bootcode in flash memory is a less than ideal solution. Additionally, flash memory cannot be written to using write instructions that are contained in the flash memory itself without some risk of data corruption. Coupled with the restriction of memory located in the code space being read only, this restricts the capability of the processor to program updates to the software in flash memory while applications are running (termed “In Application Programming”) unless other means are used, such as using two flash memories where one is updated while the other is being executed, which increases the code significantly. All of these limitations mean that using flash memory for storing and updating software, for 8051 processing systems, is not an efficient solution.

Alternatively, a fixed ROM memory can be used to contain the instructions for flash memory programming along with the bootcode. However, this creates a problem when compiling the separate code for the bootcode in ROM and the applications in flash memory, where the application in flash memory needs to call flash memory programming functions in the ROM. The 8051 architecture uses two models of compiling programs a high level language such as C. The “small model” uses the 8051 internal data (iDATA) bus with a small stack space of 256 bytes to store all function parameters, return addresses and values, which limits its use to small programs only. In the “large model,” the stack is located on the 8051 external data (XDATA) bus with 64 kB of possible space. The stack is built at compile time, which makes it difficult to call ROM functions from flash memory when compiling the code in ROM and flash memory separately, without causing stack corruption or incorrect calling sequences due to the stacks not being synchronized.

What is needed is a solution that avoids these issues.

### SUMMARY OF THE INVENTION

In a first embodiment of the present invention, a method for allowing a microprocessor to access a flash memory is provided, the method comprising: fetching code instructions and data from the flash memory via a unidirectional code bus coupled to a flash controller, which is coupled to a databus interface, which is coupled to the flash memory; executing the code instructions in a manner that is substantially similar to that as used for a read only memory (ROM) coupled to the microprocessor; and writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

In a second embodiment of the present invention, a microprocessor system is provided comprising: a central processing unit (CPU); a ROM containing bootcode and flash memory access routines; a flash memory; a flash memory controller coupled to the flash memory; a code bus interface coupled to the CPU, ROM, and flash memory controller; and a databus interface, separate and distinct from the code bus interface, coupled to the CPU and flash memory controller.

In a third embodiment of the present invention, an apparatus is provided comprising: means for fetching code instructions and data from the flash memory via a unidirectional code bus coupled to a flash controller, which is coupled to a databus interface, which is coupled to the flash memory; means for executing the code instructions in a manner that is substantially similar to that as used for a read only memory (ROM) coupled to the microprocessor; and means for writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

In a fourth embodiment of the present invention, a program storage device readable by a machine tangibly embodying a program of instructions executable by the machine to perform a method for allowing a microprocessor to access a flash memory is provided, the method comprising: fetching code instructions and data from the flash memory via a unidirectional code bus coupled to a flash controller, which is coupled to a databus interface, which is coupled to the flash memory; executing the code instructions in a manner that is substantially similar to that as used for a read only memory (ROM) coupled to the microprocessor; and writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

### BRIEF DESCRIPTION OF THE DRAWINGS

FIG. 1 is a block diagram illustrating an 8051 architecture in accordance with an embodiment of the present invention.

FIG. 2 is a block diagram illustrating one possible embodiment of flash controller of FIG. 1.

FIG. 3 is a flow diagram illustrating a method for programming a flash memory in accordance with an embodiment of the present invention.

FIG. 4 is a system flow diagram illustrating a method for programming a flash memory in accordance with an embodiment of the present invention.

FIG. 5 is a flow diagram illustrating a method for allowing a microprocessor to access a flash memory in accordance with an embodiment of the present invention.

FIG. 6 is a flow diagram illustrating a method for configuring a microprocessor system in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, a separate read-only-memory (ROM) device is provided, distinct from a serial flash memory, in an 8051 architecture. The separate ROM is used to store the bootcode, while the flash memory is used to store other data such as application code. In addition, this bootcode also contains code for writing to the flash memory using a separate interface than the read interface typically used in 8051 architectures. This allows for a distinct interface to be used to write to flash memory as to read from flash memory. In addition, a separate RAM memory is used to exchange data between the flash memory and ROM code functions. This provides for an efficient mechanism to ensure that no data corruption occurs when calling from flash memory to functions in the bootcode, and returning back to flash memory.

It should be noted that while an 8051 architecture is specifically referred to throughout this disclosure, the present invention could be extended to other microprocessor architectures that have a separate code and data bus, beyond merely 8051 architectures. The claims shall, therefore, not be construed as being limited to 8051 architectures unless expressly stated.

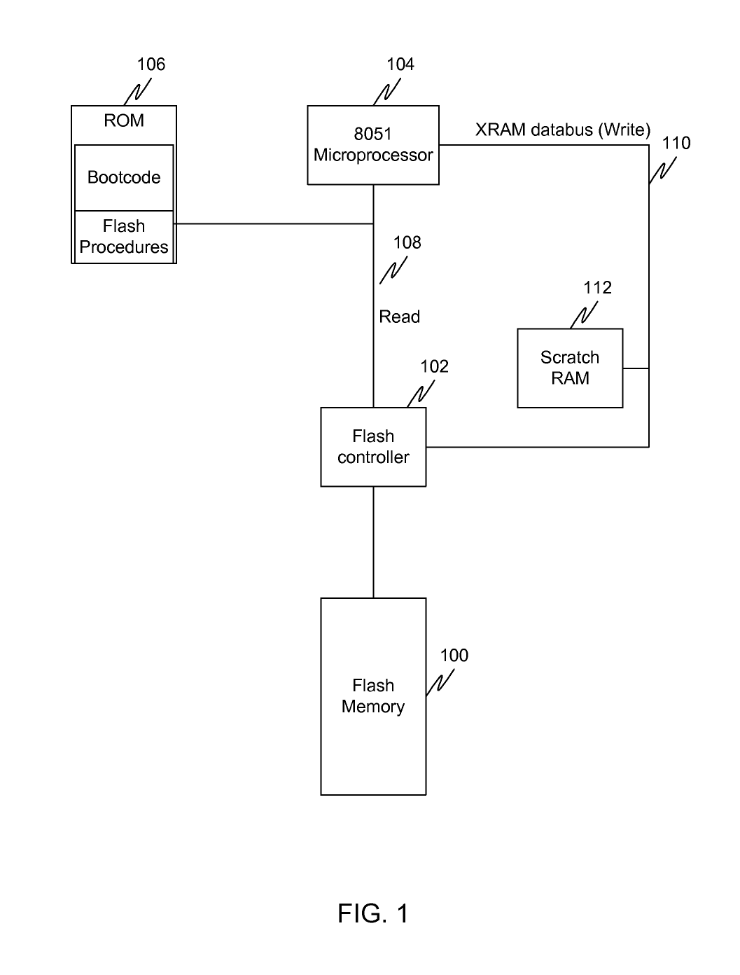

FIG. 1 is a block diagram illustrating an 8051 architecture in accordance with an embodiment of the present invention. Here, a flash memory 100 connects to a flash memory controller 102.

Flash memory controller 102 then connects to the 8051 CPU 104, which also connects to a ROM 106 containing the bootcode and flash memory access routines. These connections may all be made via a code bus 108, which is essentially a unidirectional interface where parallel data is directly retrieved via data lines after setting up an address and initiating a memory read cycle.

It should be noted that the word “unidirectional” as used throughout this document is intended to be broadly interpreted. Specifically, an address bus is often referred to as “unidirectional” because it permits one entity to directly access memory locations on another entity by presenting one set of signals (parallel address data lines and a memory read command) and reading back another set of signals (parallel data lines representing data present in the entity at the address just presented). At the hardware level, it is the case that electrical signals are passed in both directions on this bus, yet one of ordinary skill in the art still recognizes that the bus is a unidirectional communications mechanism for reading data from an entity.

When performing a read operation from flash memory 100, the 8051 CPU 104 fetches code instructions and reads data using the appropriate command lines to the flash memory 100, in an substantially similar way to that used to read the ROM 108, although the flash memory 100 is located at different physical addresses than the ROM 108. The term “substantially similar” as used in this manner shall be construed to mean having an identical general process flow. It is not, however, necessary for the exact specific process steps to be identical in order for processes to be “substantially similar.”

A separate External RAM (XRAM) databus 110 is provided between the 8051 CPU 104 and the flash controller 102 for write operations (although read operations are also possible on this databus to, for example, verify that the write operation has been completed). When performing a write operation to flash memory 100, the 8051 CPU 104 fetches the flash routine for writing from ROM 108 and then performs the write using the XRAM databus 110. This is a bidirectional interface. Each write operation is actually two operations, an erase step and a writing step. In one embodiment of the present invention, erasing is performed on a per-page basis, whereas writing is performed on a per-byte basis.

Furthermore, there is an issue in compiling bootcode in order for it to operate seamlessly with the presently claimed invention. Both the bootcode, which includes flash memory programming functions, and the application code, which calls the flash memory programming functions are written in a large memory model. The large model actually uses a memory located on the internal RAM (IRAM) or external RAM (XRAM) databus to keep its stack variables, where IRAM stores the function return address and return value only, with the rest of information being placed in XDATA. When a call instruction is made, the stack is relied upon to save the contents of any registers that need to be saved, including the return address of where execution should be resumed, usually the next instruction after the originating call instructions. The stack is also used to pass data parameters used by the called procedure. If the bootcode and flash applications are compiled together at the same time, there is no problem in maintaining the synchronization of the stack between the calling and the called code. If, however, they are compiled separately, then it becomes difficult to match up the address and data structures of the two stacks, which can result in stack corruption or incorrect code being called. In one embodiment of the present invention, space is allocated in a memory located on the XRAM databus, known as scratch RAM 112 to store a separate shared data area for the stack, and any other state information necessary to track the write operations, which is addressed directly using a fixed address, avoiding these stack mis-alignment issues.

If an update is needed to the flash procedures stored in the ROM 108, different data parameters can be placed in the scratch RAM 112 and then read and used by the flash procedures in the ROM 108. The present invention thus allows the system to handle different flash memories (e.g., different requirements as to block size or other programming requirements) with a single ROM and maintains the flexibility in parameters and scratch RAM to allow more functionality than would normally be allowed by storing information using the typical stack, which is limited in size.

It should also noted that the code for the bootcode (stored in ROM) and the code in the flash are completely compiled separately. The only thing they need to share is the address of the programmed stack in scratch RAM (e.g., an agreed offset). Otherwise, the two programs don't need to know anything about each other.

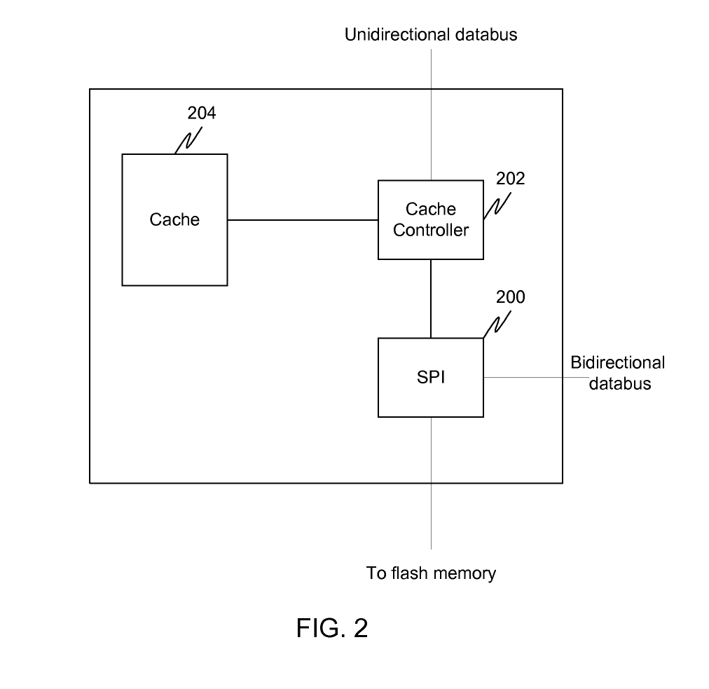

FIG. 2 is a block diagram illustrating one possible embodiment of the flash controller 102 of FIG. 1. Here, the flash controller may comprise a serial peripheral interface (SPI) 200, which connects to the flash memory. SPI connects to a cache controller 202, which controls cache RAM 204. Cache controller 202 then connects to the 8051 CPU via the unidirectional code bus 206. SPI can also connect to the 8051 CPU via the bidirectional databus 208.

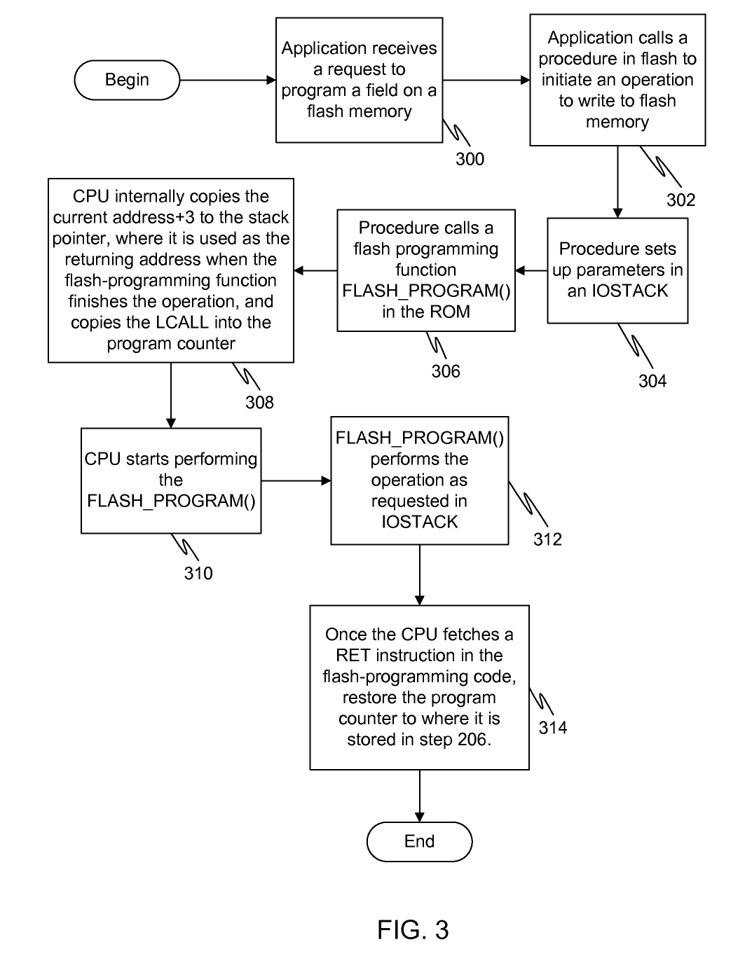

FIG. 3 is a flow diagram illustrating a method for programming a flash memory in accordance with an embodiment of the present invention. At 300, an application receives a request to program a field on the flash memory. At 302, the application calls a procedure in flash to initiate the operation to write to the flash memory. This procedure may be, for example, FlashProgrammingApplicationCode( ). At 304, this procedure sets up parameters in an IOSTACK. At 306, the procedure calls a flash programming function FLASH_PROGRAM( ) in the ROM. At 308, the CPU internally copies the current address+3 (because the LCALL takes 3 bytes long) to the stack pointer, where it is used as the returning address when the flash-programming function finishes the operation, and copies the LCALL into the program counter. At 310, the CPU starts performing the FLASH_PROGRAM( ) located in ROM. At 312, FLASH_PROGRAM( ) performs the operation with the parameters as requested in IOSTACK. At 314, once the CPU fetches a RET instruction in the flash-programming code in ROM, the program counter is restored to where it is stored in step 306, which is located in flash memory.

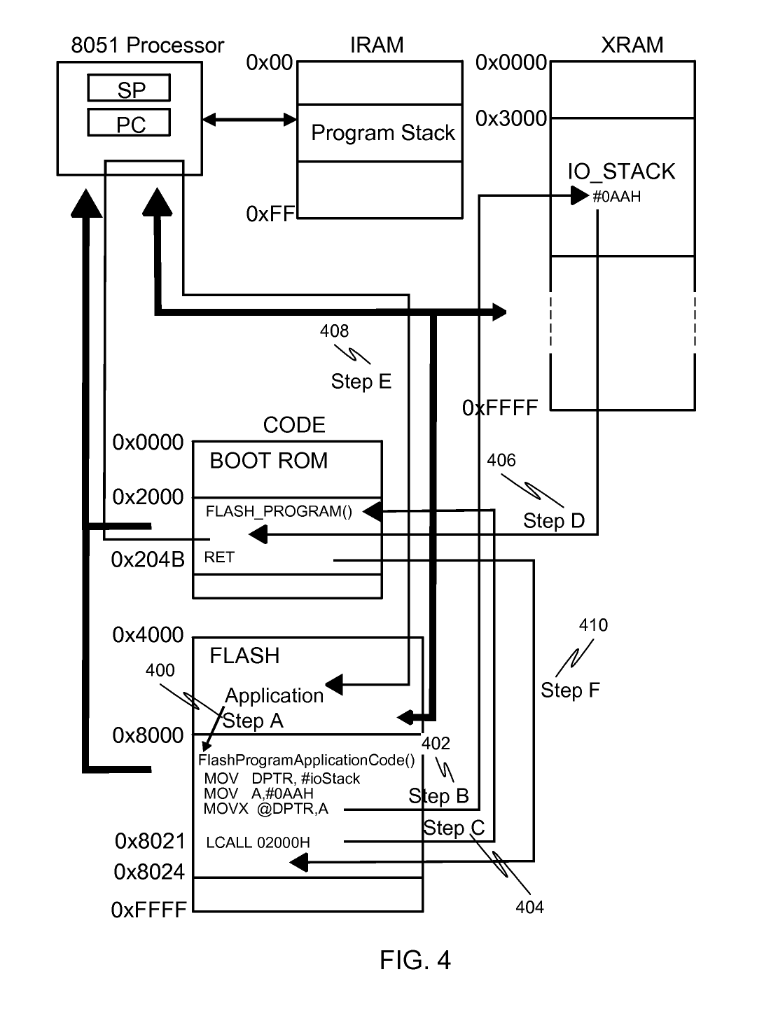

This process is also depicted in FIG. 4, which is a system flow diagram illustrating a method for programming a flash memory in accordance with an embodiment of the present invention. At step A 400, the application receives the request to program the field on the flash memory, and calls FlashProgrammingApplicationCode( ). At step B 402, the application sets up parameters in the IOSTACK. At step C 404, the application calls flash-programming function FLASH_PROGRAM( ) in the ROM using LCALL #2000. The 8051 CPU internally copies the current address+3 and copies #2000 into the program counter.

At step D 406, the 8051 CPU starts performing the FLASH_PROGRAM( ) and reads the parameters in IOSTACK. At step E 408, FLASH_PROGRAM( ) performs the operation as requested in IOSTACK. At step F 410, once the 8051 CPU fetches the RET instruction in the flash-programming code, the program counter is restored to where it is stored in step C 404.

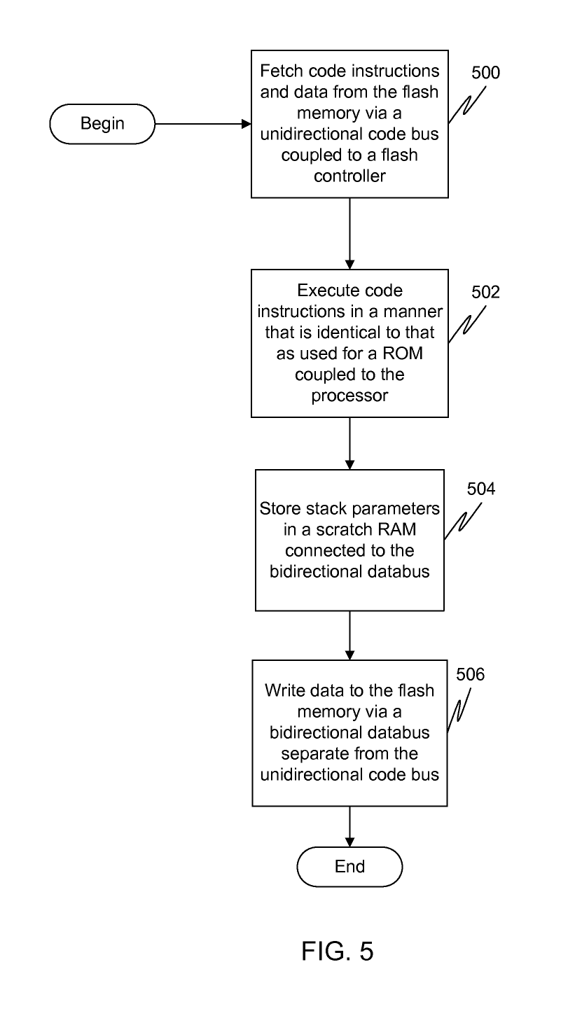

FIG. 5 is a flow diagram illustrating a method for allowing a microprocessor to access a flash memory in accordance with an embodiment of the present invention. At 500, code instructions and data are fetched from the flash memory via a unidirectional code bus coupled to the flash controller. The flash controller is coupled to a databus interface, which is coupled to the flash memory. At 502, the code instructions are executed in a manner that is substantially similar to that as used for a ROM coupled to the processor. At 504, stack parameters may be stored in a scratch RAM connected to the bidirectional databus. At 506, data is written to the flash memory via a bidirectional databus separate from the unidirectional code bus. The bidirectional databus is coupled to the databus interface and to a scratch memory. The writing comprises using write flash procedures located in the ROM, the write flash procedures comprising instructions for reading and using parameter values stored in the scratch memory and for erasing memory locations and writing data to memory locations in the flash memory.

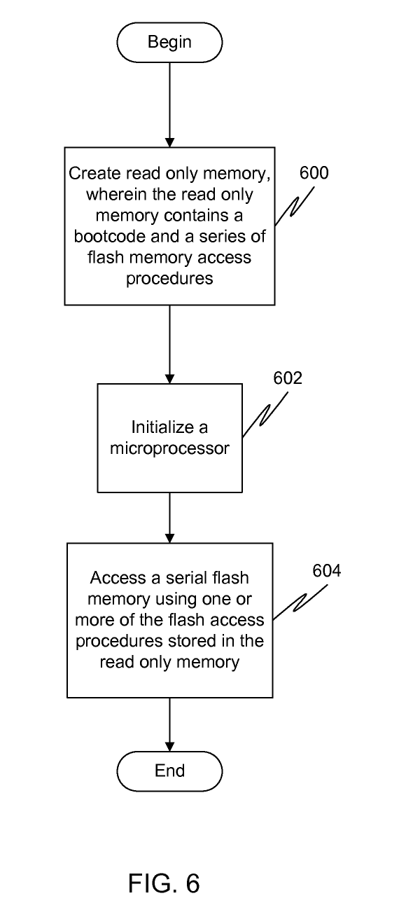

FIG. 6 is a flow diagram illustrating a method for configuring a microprocessor system in accordance with an embodiment of the present invention. At 600, read only memory is created, wherein the read only memory contains a bootcode and a series of flash memory access procedures. At 602, a microprocessor is initialized, wherein the initialization includes retrieving the bootcode from the read only memory and executing the bootcode.

At 604, a serial flash memory is accessed using one or more of the flash memory access procedures stored in the read only memory. The serial flash memory is accessed either via a unidirectional code bus (for read commands) or via a bidirectional databus separate from the unidirectional code bus (for write commands).

The present invention allows an application to reprogram a field on a storage area where it is shared with the code being run (runtime code). It is also able to perform these tasks without resetting the microprocessor, which would result in the loss of content of a previous state. The present invention is thus able to reprogram code space memory while the system is communicating with other interfaces.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for allowing a microprocessor to access a flash memory, the method comprising:
fetching code instructions and data from the flash memory via a unidirectional code bus coupled to a flash controller, which is coupled to a databus interface, which is coupled to the flash memory;
executing the code instructions in a manner that is substantially similar to that as used for a read only memory (ROM) coupled to the microprocessor; and
writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

2. The method of claim 1, wherein the bidirectional databus is an External Random Access Memory (XRAM) databus.

3. The method of claim 1, further comprising:
storing state parameters in a scratch random access memory (RAM) connected to the bidirectional databus in response to said writing the data to the flash memory.

4. The method of claim 1, wherein the ROM also contains bootcode.

5. The method of claim 1, wherein the fetching includes utilizing a serial peripheral interface (SPI) connected to the unidirectional code bus.

6. The method of claim 5, wherein the SPI utilizes a cache controller connected to the unidirectional code bus, and the cache controller accesses a cache RAM.

7. The method of claim 1, wherein code stored in the ROM is compiled separately from application code stored in the flash memory.

8. The method of claim 1, wherein the microprocessor is an 8051 processor.

9. A microprocessor system comprising:
a central processing unit (CPU);
a ROM containing bootcode and flash memory access routines;
a flash memory;
a flash memory controller coupled to the flash memory;
a code bus interface coupled to the CPU, ROM, and flash memory controller; and
a databus interface, separate and distinct from the code bus interface, coupled to the CPU and flash memory controller.

10. The microprocessor system of claim 9, wherein the code bus interface is configured to transfer data read from the flash memory to the CPU, and wherein the databus interface is configured to erase sections of the flash memory and to transfer data written to the flash memory from the CPU.

11. The microprocessor system of claim 10, wherein the flash memory access routines from the ROM are used to configure the code bus interface and the databus interface.

12. The microprocessor system of claim 9, further comprising a scratch RAM coupled to the databus interface.

13. The microprocessor system of claim 12, wherein the scratch RAM includes stack information.

14. An apparatus comprising:
means for fetching code instructions and data from the flash memory via a unidirectional code bus coupled to a flash controller, which is coupled to a databus interface, which is coupled to the flash memory;
means for executing the code instructions in a manner that is substantially similar to that as used for a read only memory (ROM) coupled to the microprocessor; and
means for writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

15. The apparatus of claim 14, further comprising:
means for storing state parameters in a scratch random access memory (RAM) connected to the bidirectional databus in response to said writing the data to the flash memory.

16. The apparatus of claim 14, wherein the ROM also contains bootcode.

17. A program storage device readable by a machine tangibly embodying a program of instructions executable by the machine to perform a method for allowing a microprocessor to access a flash memory, the method comprising:
fetching code instructions and data from the flash memory via a unidirectional code bus coupled to a flash controller, which is coupled to a databus interface, which is coupled to the flash memory;
executing the code instructions in a manner that is substantially similar to that as used for a read only memory (ROM) coupled to the microprocessor; and
writing data to the flash memory via a bidirectional databus separate from the unidirectional code bus, wherein the bidirectional databus is coupled to the databus interface and to a scratch memory, wherein the writing comprises using write flash procedures located in the ROM, the write flash procedures comprising instructions for reading and using parameter values stored in the scratch memory and for erasing memory locations and writing data to memory locations in the flash memory.

18. The program storage device of claim 17, wherein the bidirectional databus is an External Random Access Memory (XRAM) databus.

19. The program storage device of claim 17, wherein the fetching includes utilizing a serial peripheral interface (SPI) connected to the unidirectional code bus.
